(19) United States
(12) Patent Application Publication
(10) Pub. No.: US 2026/0316048 A1
(43) Pub. Date: Oct. 15, 2026

(54) METHOD AND COMPOSITION FOR GRANULAR ACTIVATED CARBONS WITH ENHANCED HARDNESS AND ADSORPTIVE PROPERTIES

(71) Applicant: ADA CARBON SOLUTIONS, LLC, Greenwood Village, CO (US)

(72) Inventors: Mowen LI, Highlands Ranch, CO (US); Lingyan SONG, Englewood, CO (US); Micala MITCHEK, Denver, CO (US); Joseph M. WONG, Castle Pines, CO (US)

(21) Appl. No.: 19/485,088

(22) PCT Filed: May 17, 2024
(86) PCT No.: PCT/US2024/030063

§ 371 Date: Nov. 17, 2025

Related U.S. Application Data
(60) Provisional application No. 63/467,237, filed on May 17, 2023.
(60) Provisional application No. 63/467,521, filed on May 18, 2023.
(60) Provisional application No. 63/468,984, filed on May 25, 2023.

(51) Int. Cl. B01J 20/20; B01J 20/28

(52) U.S. Cl. CPC B01J 20/20; B01J 20/28004; B01J 20/28011; B01J 20/28071; B01J 2220/4812

(57) ABSTRACT

The present disclosure is directed to an activated carbon-based sorbent composition for the sequestration of contaminants from a medium, methods for sequestering the contaminants from the medium, and a method for the manufacture of an activated carbon-based sorbent composition. The activated carbon of the sorbent composition may be derived from low ranking coal, such as sub-bituminous coal, lignite coal, PRB coal), non-coking coal or “soft” starting materials such as cellulosic material, such as wood fiber, peat, soft nutshells. The activated carbon-based sorbent composition includes one or more binding agents to increase the mechanical hardness of the composition. The method comprises reagglomerating a carbon-comprising feedstock with the one or more binding agents before activating the composition to form the activated carbon-based sorbent composition useful for the sequestration of contaminants from a medium.

### CROSS REFERENCES

This application claims priority to U.S. Provisional Patent Application No. 63/467,237, filed May 17, 2023, U.S. Provisional Patent Application No. 63/467,521, filed May 18, 2023, and U.S. Provisional Patent Application No. 63/468,984, filed May 25, 2023, each entitled “METHOD AND COMPOSITION FOR GRANULAR ACTIVATED CARBONS WITH ENHANCED HARDNESS AND ADSORPTIVE PROPERTIES,” all of which are incorporated herein by reference in their entireties.

### FIELD

The disclosure relates generally to activated carbon-based sorbent materials for treatment of contaminated media and particularly to reagglomerated activated carbon-based sorbent materials for treatment of contaminated media.

### BACKGROUND

Activated carbon-based sorbent materials, such as those made from lignite coal, Powder River Basin (PRB) coal, bituminous coal, coconut shells, wood, nutshells, cellulose or any other carbon-containing material, are used in powdered (i.e., less than about 177 micron particle size), granular (i.e., greater than about 177 micron particle size) and other sizes and shapes for a host of gas and liquid-phase contaminant removal applications. The activated carbon-based sorbent materials are typically manufactured by heating the raw organic materials that are high in carbon in the absence of oxygen. This process increases the surface area of the carbon, making the sorbent material highly porous and suitable for removing contaminants from liquids, gases, or solids.

The material and form of the activated carbon deployed is highly dependent on the end-use application. In one example for coal-fired power plant flue gas treatment to remove mercury, “small” particle sized powder activated carbon (PAC) is injected into the flue gas and is highly dispersed to contact, convert and capture the mercury. In another example for taste and odor contaminant removal from municipal potable water purification, PAC is dispersed in the raw water and in its highly dispersed form is very effective in removing the contaminants. In yet another example, large-particle granular activated carbons (GAC) are used predominantly in applications employing a stream of contaminated gas or liquid flowing through a column or vessel of packed GAC. In this example, the “large” size GAC particles allow the stream to flow through the packed carbon bed at high flowrates, with low pressure drop and high contact with the contaminant. The GAC not only needs to have the adsorptive (e.g., physiochemical) properties, but it also needs to have sufficient mechanical properties, particularly relating to hardness and dustiness for efficient contaminant removal and for proper functioning in process equipment.

A property that gives an indication of the hardness and integrity of a GAC is Ball Pan Hardness (BPH). Particularly, a BPH value indicates the degradation resistance of a GAC. A GAC with a BPH value greater than about 60% is typically considered to have sufficient degradation resistance for use in contaminant removal. As such, GACs produced commercially are made traditionally from dense starting materials, such as bituminous coal, reagglomerated bituminous coal, coconut, etc. that result in hard (e.g., strong) particles that maintain their size and shape during use and typically result in a BPH about 60-95%.

Activation of low-rank coal, sub-bituminous coal or cellulosic material (e.g., wood, fiber, etc.) such as by direct steam, on the other hand, may also be used to produce a GAC with desired adsorptive properties, such as properties beneficial for sequestering a particular target contaminant. In some cases, it may be cheaper to manufacture a GAC from low-rank coal, sub-bituminous coal or cellulosic material. A GAC manufactured from the low-rank coal, sub-bituminous coal or cellulosic material, however, may not exhibit desired mechanical hardness (i.e., BPH less than about 50%) and/or achieve the low dust levels necessary for market application. In some embodiments, a GAC manufactured from the low-rank coal, sub-bituminous coal or cellulosic material may be considerably more dusty than a GAC manufactured from denser starting materials, such as the bituminous coal, reagglomerated bituminous coal, coconut, etc. (e.g., dust is measured by carbon particles passing a 325 mesh screen of greater than about 0.4 wt. %).

There is therefore a need for an activated carbon-based sorbent that demonstrates sufficient mechanical hardness and comprises minimized dust quantities that is manufactured from low-rank coal, sub-bituminous coal, cellulosic material, or some other “soft” carbon-comprising material for use in contaminant removal techniques.

### SUMMARY

These and other needs are addressed by the various embodiments and configurations of the present disclosure. This disclosure provides an activated carbon-based sorbent composition comprising activated carbon derived from low ranking coal (e.g., sub-bituminous coal, lignite coal, PRB coal, etc.) or “soft” starting materials such as cellulosic material (e.g., wood fiber, peat, soft nutshells, etc.). The low rank coal and/or other “soft” starting material may be reagglomerated with at least one binding agent and sized to form a hard (i.e., greater than about 60% BPH), highly adsorptive activated-carbon based sorbent composition. In some embodiments, the resulting activated-carbon based sorbent composition comprises granules having a median average particle size greater than about 177 microns.

The present disclosure provides a carbon-comprising sorbent material, comprising a carbon-rich material, and one or more binding agents, wherein the carbon-comprising sorbent material comprises a medium particle size greater than about 177 μm and comprises a ball pan hardness of at least about 60%. The present disclosure additionally provides methods of manufacturing, and use of the carbon-comprising sorbent material.

In some embodiments, the carbon-comprising sorbent material comprises a ball pan hardness of at least about 65%.

In some embodiments, the carbon-comprising sorbent material comprises a dust level less than about 0.4 wt. % (dry basis).

In some embodiments, the carbon-comprising sorbent material comprises a total pore volume of at least about 0.2 cc/g.

In some embodiments, the carbon-comprising sorbent material comprises a ratio of micropore volume to mesopore volume of at least about 0.2 and not greater than about 2.0.

In some embodiments, the carbon-rich material is derived from lignite coal, sub-bituminous coal, Powder River Basin (PRB) coal, wood, peat, nutshells, non-coking coal, and a combination thereof.

In some embodiments, the one or more binding agents comprise a green strength binder selected from the group comprising hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethylmethyl cellulose, xanthan gum derivatives, guar gum derivatives, hydroxypropyl guar gum, Polyacrylates derivatives, Acrylates/C10-C30 Alkyl Acrylate cross-polymer, Carbomer, and Polyacrylate-1 cross-polymer.

In some embodiments, the one or more binding agents comprise an activation binder selected from the group comprising gilsonite, resinous rock, asphalt, asphalt, uintahite, coal tar pitch, petroleum pitch, oil sands, bitumen, resinous hydrocarbon, heavy oil, carbon pitch, coal tar distillates, clays, and mixtures thereof.

In some embodiments, the carbon-rich material and the one or more binding agents are homogenously distributed in the carbon-comprising sorbent material.

The present disclosure provides a method of manufacturing an granular activated carbon-rich sorbent material, comprising combining a carbon-rich feedstock material with one or more binding agents to form an intermediate composition, forming the intermediate composition into granules comprising a medium particle size greater than about 177 μm to form a granular intermediate composition, and activating the granular intermediate composition to form the granular activated carbon-rich sorbent material. The present disclosure additionally provides a method of using the manufactured granular activated carbon-rich sorbent material.

In some embodiments, the granular activated carbon-rich sorbent material comprises a ball pan hardness of at least about 60%.

In some embodiments, the granular activated carbon-rich sorbent material comprises a dust level less than about 0.4 wt. % (dry basis).

In some embodiments, the granular activated carbon-rich sorbent material comprises a total pore volume of at least about 0.2 cc/g.

In some embodiments, the granular activated carbon-rich sorbent material comprises a ratio of micropore volume to mesopore volume of at least about 0.2 and not greater than about 2.0.

In some embodiments, the carbon-rich feedstock material is derived from lignite coal, sub-bituminous coal, Powder River Basin (PRB) coal, wood, peat, nutshells, non-coking coal, and a combination thereof.

In some embodiments, the one or more binding agents comprise a green strength binder selected from the group comprising hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethylmethyl cellulose, xanthan gum derivatives, guar gum derivatives, hydroxypropyl guar gum, Polyacrylates derivatives, Acrylates/C10-C30 Alkyl Acrylate cross-polymer, Carbomer, and Polyacrylate-1 cross-polymer.

In some embodiments, the one or more binding agents comprise an activation binder selected from the group comprising gilsonite, resinous rock, asphalt, asphalt, uintahite, coal tar pitch, petroleum pitch, oil sands, bitumen, resinous hydrocarbon, heavy oil, carbon pitch, coal tar distillates, clays, and mixtures thereof.

In some embodiments, the combining step comprises homogenously distributing the carbon-rich feedstock material and the one or more binding agents to form the intermediate composition.

The present disclosure provides an activated carbon-comprising sorbent composition, comprising a carbon-rich material derived from a feedstock comprising one or more of lignite coal, sub-bituminous coal, Powder River Basin (PRB) coal, wood, peat, and nutshells, and one or more binding agents, wherein the carbon-comprising sorbent material comprises a ball pan hardness of at least about 60%. The present disclosure additionally provides methods of manufacturing, and use of the activated carbon-comprising sorbent composition.

In some embodiments, the activated carbon-comprising sorbent composition comprises a medium particle size greater than about 177 μm.

In some embodiments, the activated carbon-comprising sorbent composition comprises ball pan hardness of at least about 75%.

The present disclosure can achieve a number of advantages. The present disclosure can provide a sorbent composition comprising at least a base activated carbon material and one or more binding agents tailored to increase the mechanical hardness and/or reduce the dust levels of the sorbent composition. Due at least in part to the incorporation of the binding agent, the base activated material may comprise “soft” raw materials, such as low ranking coal or cellulosic material (e.g., wood fiber, peat, soft nutshells, etc.). In some embodiments, the soft starting materials may be more cost effective than “hard” starting materials, such as bituminous coal, reagglomerated bituminous coal, coconut, etc.

Additionally, one or more properties associated with a “soft” starting material may be favorable over a “hard” starting material. For example, properties of an activated carbon-based sorbent composition are at least partially based on the material from which the activated carbon is sourced. Bituminous coal-based sorbent may demonstrate hydrophobic tendencies and may have a higher quantity of micropores and/or mesopores. As will be appreciated, the pores in activated carbons are scattered over a wide range of size and shape. The pores are typically classified by their sizes usually into three groups: (i) macropores having average diameter more than 50 nm, (ii) mesopores with an average diameter in the range of 2-50 nm, and (iii) micropores having an average diameter less than 2 nm. In contrast, a lignite-based sorbent may demonstrate hydrophilic tendencies and may result in larger mesopores. Such properties may be exploited for sequestering certain contaminants. In some embodiments, it may be beneficial to use a particular starting material to achieve desired sorption properties but that starting material may conventionally be too soft for the end use application (e.g., GAC). Embodiments of the present disclosure address this need at least by the incorporation of one or more binding agents into the activated carbon-based sorbent.

As such, according to aspects of the present disclosure, an activated carbon-based sorbent composition is produced from starting materials not conventionally used to manufacture GAC and may achieve similar or improved mechanical hardness, with similar or improved dust levels, at an improved cost, and/or with properties tuned to an end-use application or target contaminant.

These and other advantages will be apparent from the disclosure contained herein.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a flowchart illustrating an example method of manufacturing an activated carbon (AC)-based sorbent composition according to embodiments of the disclosure.

FIG. 2 illustrates a plot of Freundlich Isotherm plots showing the adsorption performance of lignite-based AC versus bituminous-based AC for vinyl chloride adsorption, according to an embodiment of the disclosure.

FIG. 3 illustrates a plot of Freundlich Isotherm plots showing the adsorption performance of lignite-based AC versus bituminous-based AC for cis-dichloroethylene adsorption, according to an embodiment of the disclosure.

FIG. 4 illustrates a plot of Freundlich Isotherm plots showing the adsorption performance of lignite-based AC versus bituminous-based AC for trichloroethylene adsorption, according to an embodiment of the disclosure.

FIG. 5 illustrates a plot of Freundlich Isotherm plots showing the adsorption performance of lignite-based AC versus bituminous-based AC for tetrachloroethylene adsorption, according to an embodiment of the disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase-gas, liquid or solid material. This is a different process from adsorption, since molecules undergoing absorption are taken up by the volume, not by the surface (as in the case for adsorption).

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces)) or chemisorption (characteristic of covalent bonding). It may also occur due to electrostatic attraction.

“Agglomerates” are particle composites formed by smaller particles bonded together, typically by an organic, inorganic, or compound binder, to form larger and stable agglomerates. Agglomeration can occur in a variety of ways, including mechanical, thermal, or chemical methods. An agglomerate of the present disclosure may refer to native coal particles. A re-agglomerate of the present disclosure may refer to or may be referred to as a “granule” and may include one or more binding agents.

As used herein, “carbon-rich” refers to a material comprising at least about 50, more commonly at least about 55, more commonly at least about 60, more commonly at least about 65, more commonly at least about 70, more commonly at least about 75, more commonly at least about 80, more commonly at least about 85, and even more commonly at least about 90 wt. % (wet or dry basis) carbon or carbon-containing compounds.

A “sorbent” is a material that sorbs another substance; that is, the material has the capacity or tendency to take it up by sorption.

“Sorb” means to take up a liquid or a gas by sorption.

“Sorption” refers to adsorption and absorption, while desorption is the reverse of adsorption.

“Contaminants” as used herein, refers to contaminants found in composition target for clean-up. Target compositions may include flue gases, contaminated soil and groundwater, municipal water, wastewater, industrial water, wastewater, industrial gases, military gases, biogas, . . . . Exemplary contaminants may include inorganic contaminants such as hydrogen sulfide (H₂S), coal combustion residuals (CCRs), such as arsenic (As), cobalt (Co), lithium (Li), molybdenum (Mo), and boron (B) and organic contaminants such as (petroleum) hydrocarbons, chlorinated solvents, PFAS, etc.

“Sequestration pores” refer to micropores of an activated carbon-comprising composition.

“Diffusion pores” refer to mesopores of an activated carbon-comprising composition, and may otherwise be referred to a transportation pores.

“Activated carbon” or “AC” refers to an amorphous carbon that has been treated with steam and heat to exhibit strong affinity for adsorbing target contaminants.

“Fixed carbon” refers to the remaining carbon after carbonization process and the activation process, demonstrated by: % Fixed carbon=100%−(% volatile matter content−% ash content).

“Soft raw material” refers to a carbon-comprising material derived from low ranking coal (e.g., sub-bituminous coal, lignite coal, PRB coal) or “soft” starting materials such as cellulosic material (e.g., wood fiber, peat, soft nutshells), and may otherwise be referred to as “soft starting material,” “soft sourcing material,” “soft feedstock,” or the like.

“Hard raw material” refers to dense carbon-comprising materials such as bituminous coal, reagglomerated bituminous coal, coconut, etc. and may otherwise be referred to as “hard starting material,” “hard sourcing material,” “hard feedstock,” or the like.

“Non-coking coal,” as used herein, refers to coal that does not possess the necessary properties for coking and the production of coke such that it cannot soften and re-solidify like coking coal during the coking process. “Non-coking coal” can include bituminous coal, re-agglomerated bituminous coal, and coconut-based coal and may also be referred to as thermal coal or steam coal.

“Binding agent” refers to a material or substance that holds other materials together mechanically and/or chemically to form a cohesive whole and may otherwise be referred to as a “binder”, “binder material,” “bonding agent,” “adhesive,” “adhesion agent,” “connection agent,” “coupling agent,” and “fixing agent.”

“Petroleum hydrocarbons” refer to the primary constituents in crude oil, gasoline, diesel, and a variety of solvents and penetrating oils, including but not limited to benzene, toluene, ethylbenzene, and xylenes (BTEX). Petroleum hydrocarbons may otherwise be referred to herein as BTEX compounds.

“Chlorinated solvents” refer to common groundwater contaminants and their degradation (breakdown products), including but not limited to vinyl chloride (VC), tetrachloroethylene (PCE) (also known as perchloroethylene or “PERC”), trichloroethylene (TCE), and dichloroethylene (DCE). Chlorinated solvents may otherwise be referred to herein as chlorinated volatile organic compounds (CVOCs).

“PFAS” as used herein refers to per and polyfluoroalkyl substances including but not limited to polyfluorooctanoic acid (PFOA), perfluorooctane sulfonic acid (PFOS), and perfluorobutane sulfonic acid (PFBS).

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

The present disclosure is directed to activated carbon-based sorbent compositions, methods for making the activated carbon-based sorbent compositions and methods for using the activated carbon-based sorbent compositions, e.g., to remove, adsorb, immobilize, and/or sequester, organic and/or inorganic contaminant species from contaminated mediums. Embodiments of the present disclosure allow for the selection of desired carbon-comprising starting materials (e.g., based on contaminants targeted for removal, an overall composition of a contaminant medium, end-use application, cost) for use in activated carbon-based sorbent compositions, regardless of the end-use size of the activated carbon-based sorbent composition. Additionally, the activated carbon-based sorbent compositions and/or the activated carbon of the compositions may include physical and chemical properties to enhance the mechanism of contaminant physisorption and chemisorption including enhanced adsorption kinetics through manipulation of particle surface area, enhanced capacity and selectivity through controlled pore size distribution, and enhanced electrostatic and hydrophobic interactions with contaminants.

Embodiments of the present disclosure are generally related to novel activated carbon-based (carbon-rich) sorbent compositions comprising a base sorbent material of activated carbon derived from one or more low ranking coal sources (e.g., sub-bituminous coal, lignite coal, PRB coal, etc.), one or more “soft” starting materials such as cellulosic material (e.g., wood fiber, peat, soft nutshells, etc.), one or more “dense” starting materials not considered to be a coking or metallurgical grade material (e.g., non-coking coal), and combinations thereof. The activated carbon-based sorbent compositions additionally includes one or more binding agents to enhance mechanical properties of the sorbent composition. For example, the carbon-comprising starting material may be re-agglomerated with at least one binding agent to form a hard (i.e., greater than about 60% BPH), highly adsorptive activated-carbon based sorbent composition.

The at least one binding agent can be any suitable binder that is integral to developing the final activated hardness. In some embodiments, the binding agent may aid in developing cohesion and density of the particles that achieve the final hardness of the activated carbon-based sorbent composition, and may be referred to as “green strength binders.” That is, green strength binders serve to maintain intactness and enhance hardness of the reagglomerated activated carbon-based sorbent compositions such that the reagglomerated compositions are able to proceed through subsequent machinery without appreciable attrition. Green strength binders sets and continue to function (e.g., provide hardness enhancement) from about room temperatures to about 460° C. The one or more green strength binders may be selected from the group including hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, xanthan gum derivatives, guar gum derivatives, hydroxypropyl guar gum, polyacrylates derivatives, Acrylates/C10-C30 Alkyl Acrylate cross-polymer, Carbomer, Polyacrylate-1 cross-polymer, and the like.

Additionally, or alternatively, the binding agent may aid in developing cohesion and density of the particles that achieve the final hardness of the activated carbon-based sorbent composition and may be referred to as “activation binders.” Activation binders may set at around 460° C. and strengthen up to temperatures of about 1100° C., such as through activation of the re-agglomerated composition The one or more activation binders may be selected from the group including gilsonite, resinous rock, asphalt, asphalt, uintahite, coal tar pitch, petroleum pitch, oil sands, bitumen, resinous hydrocarbon, heavy oil, carbon pitch, coal tar distillates, clays such as bentonite, and the like.

In a non-limiting example of utilizing both green strength and activation binders in a composition, a green strength binder functions from about room temperature right up or near the point the activation binder activates or the coal cokes/thermosets, such as about 460° C. The activation binder sets at a charring temperature of around 460° C. and strengthens through the activation process up to 1100° C. to provide strength to the final activated composition. The activation binder is present for the entire temperature profile from about room temperature to about 1100° C. As the activation binder does not set until the higher temperatures, a green strength binder may be needed at the lower temperatures to enhance the hardness of the composition in the early, low-temperature stages of the process.

Other binders that may be included in the activated carbon-based sorbent composition may include starch, molasses, gum Arabic, cement, sodium silicate, lime, wood pitch, petroleum pitch, peat tar pitch, alkali cellulose or phenol aldehyde resins, and mixtures thereof.

Other organic, inorganic, and compound binders may be employed, such as inactive film binders, chemical film binders, inactive matrix binders, chemical matrix binders, and chemical reaction binders. In some applications, lignin in the carbon rich material can be employed as the binder. A coking coal, such as a high-ranking bituminous coal, can also be used as a binder. High compaction pressure can be used to release sufficient naturally occurring lignin to act as a naturally occurring binder.

The activated carbon-based sorbent composition may comprise a total binder content typically ranging from about 0.1 to about 20 wt. %, or more typically from about 0.25 to about 15 wt. %, or more typically from about 0.5 to about 10 wt. %, or even more typically from about 1 to about 6 wt. % (dry or wet basis). Stated differently, the activated carbon-based sorbent composition may comprise a total binder content less than about 20 wt. %, or more typically less than about 15 wt. %, or more typically less than about 10 wt. %, or more typically less than about 9 wt. %, or more typically less than about 8 wt. %, or more typically less than about 7 wt. %, or even more typically less than about 6 wt. % (dry or wet basis). In some embodiments, the activated carbon-based sorbent composition may comprise a total binder content less than about 5 wt. %, or more typically less than about 4 wt. %, or more typically less than about 3 wt. %, or even more typically less than about 2 wt. % (dry or wet basis).

In embodiments, the sorbent composition may comprise a green strength binder content typically ranging from about 0.01 to about 15 wt. %, or more preferably from about 0.1 to about 10 wt. %, or more preferably from about 0.25 to about 5 wt. %, or even more preferably from about 0.5 to 2 wt. % (dry or wet basis). Stated differently, the activated carbon-based sorbent composition may comprise a green strength binder content less than about 15 wt. %, or more preferably less than about 10 wt. %, or more preferably less than about 5 wt. %, or even more preferably less than about 2 wt. % (dry or wet basis). In some embodiments, the green strength binder content may be less than about 0.5 wt. %, less than about 0.25 wt. %, or less than about 0.1 wt. % (dry or wet basis).

In embodiments, the sorbent composition may comprise an activation binder content typically ranging from about 0 to about 15 wt. %, or preferably from about 0.5 to about 10 wt. %, or preferably from about 1 to about 5 wt. %, or even more preferably about 2 to about 4 wt. % (dry or wet basis). Stated differently, the activated carbon-based sorbent composition may comprise an activation binder content less than about 15 wt. %, or preferably less than about 10 wt. %, or preferably less than about 5 wt. %, or even more preferably less than about 4 wt. % (dry or wet basis). In some embodiments, the activation binder content may be less than about 2 wt. %, or less than about 1 wt. %, or about 0 wt. % (dry or wet basis). An activation binder may not be needed in embodiments where the carbonaceous feed inherently contains sufficient coking properties.

The activated carbon-based sorbent composition may comprise at least about 20 wt. %, or more particularly at least about 30 wt. %, or more particularly at least about 40 wt. %, or more particularly at least about 50 wt. % of fixed carbon and not greater than about 100 wt. %, or more particularly not greater than about 95 wt. %, or more particularly not greater than about 90 wt. %, or more particularly not greater than about 80 wt. % fixed carbon (dry or wet basis). Stated differently, the activated carbon-based sorbent composition comprises between about 30-100 wt. % of fixed carbon, or more particularly between about 40-90 wt. % of fixed carbon, or even more particularly between about 50-80 wt. % of fixed carbon (dry or wet basis).

According to embodiments of the present disclosure, the activated carbon-based sorbent composition may comprise a base carbon-comprising material derived from one or more “soft” carbon-comprising materials. Non-limiting examples of “soft” materials include low-rank coals, such as sub-bituminous or lignite coals and PRB coals, cellulosic raw materials, such as wood, nutshells, and peat, and combinations thereof.

Additionally or alternatively, the activated carbon-based sorbent composition may comprise a base carbon-comprising material derived from one or more “dense” or “hard” carbon-comprising materials that are not considered as coking or metallurgical grade materials. Non-limiting examples of “dense” or “hard” materials include bituminous coals, reagglomerated bituminous coal, coconut, etc.

The one or more starting materials selected for use in the activated carbon-based sorbent composition may be based on several factors including but not limited to the one or more contaminants being targeted for removal from a contaminated medium, an overall composition of a contaminated medium, end-use application (e.g., water treatment in a pressure vessel or gravity filter, trenching, packing in a flue gas column, a biogas purification vessel), cost, etc. For example, it may be more cost effective to manufacture a sorbent material of the present disclosure comprising lignite coal as compared to bituminous coal. Additionally, different contaminants may be associated with particular characteristics that may impact a contaminant's sequestration into a sorbent composition, such as hydrophobicity, size, charge, etc. Certain starting materials may be more effective at attracting and/or sequestering certain target contaminants. Additionally or alternatively, certain carbon-comprising starting materials may be capable of higher selectivity of contaminants removed from a contaminated medium. By contrast, some starting materials may be capable of broad sequestration of contaminants in a contaminated medium. Properties associated with the carbon-comprising starting material may be exploited to achieve an activated carbon-based sorbent composition with desired functionalities (e.g., hardness, hydrophilicity or hydrophobicity, pore size, surface area, surface charge).

By way of a non-limiting example, lignite is inherently more hydrophilic compared to bituminous and coconut-based carbon, and bituminous is considered very hydrophobic, as described in more detail below. With reference to charge, lignite, bituminous, and coconut based carbon are each inherently positively charged, with lignite containing more mineral content, thereby potentially providing a catalytic effect. Where coconut-based carbons are generally dominated by micropores, both lignite and bituminous-based carbons typically have a distribution of micropores and mesopores. Generally, lignite-based carbons have a larger proportion of mesopores compared to micropores and vice versa for bituminous-based carbons. Lignite may have the advantage over other carbon sources in terms of pore ratio for contaminant transportation, but the disadvantage in that the micropore volume is lower than bituminous-based carbon. However, the surface functionality of bituminous is much lower than lignite which makes the bituminous surface very hydrophobic compared to lignite.

To improve the efficiency of contaminant sequestration, methods of the present disclosure are directed to manufacturing an activated carbon-based sorbent composition based at least on one or more properties of a target contaminant(s). In a non-limiting example, lignite's properties may be beneficial in capturing short chain PFAS, acid gas and CVOCs contaminants, whereas bituminous coal's properties may be beneficial for use in capturing long chain PFAS and petroleum hydrocarbons contaminants.

In some embodiments, the activated carbon particles comprise at least about 10 wt. %, such as at least about 20 wt. %, at least about 30 wt. %, at least about 40 wt. %, or even at least about 50 wt. % of the activated carbon-based sorbent composition (dry or wet basis). In some embodiments, the activated carbon particles comprise up to about 99.9 wt. %, such as up to about 99.5 wt. %, up to about 90 wt. %, up to about 80 wt. %, or even at least about 75 wt. % of the activated carbon-based sorbent composition (dry or wet basis). Stated differently, the activated carbon particles comprise between about 20 to about 99.5 wt. %, or more typically about 30 to 90 wt. %, or more typically about 40 to 80 wt. %, or more typically about 50 to 75 wt. % of the activated carbon-based sorbent composition (dry or wet basis).

The activated carbon-based sorbent composition of the present disclosure comprises at least about 1 wt. %, or more particularly about 1.5 wt. %, or more particularly about 2 wt. %, or more particularly at least about 5 wt. %, or even more particularly at least about 10 wt. % of minerals and not greater than about 80 wt. %, or more particularly not greater than about 70 wt. %, or more particularly not greater than about 60 wt. %, more particularly not greater than about 50 wt. % of minerals (dry or wet basis). Stated differently, the activated carbon-based sorbent composition comprises between about 2-80 wt. % of minerals, or more particularly between about 5-70 wt. % of minerals, or even more particularly between about 1.0-50 wt. % of minerals (dry or wet basis). Minerals included in the sorbent composition may include aluminosilicates, metal oxides, metal carbonates, etc.

The activated carbon-based sorbent composition may comprise at least about 0.5 wt. % iron, or more typically at least about 1 wt. % iron on a dry weight basis. The activated carbon-based sorbent composition may comprise at least about 0.5 wt. % calcium, or more typically at least about 1 wt. % calcium on a dry weight basis. The sorbent composition may comprise at least about 100 mg/kg titanium, or more typically at least about 300 mg/kg titanium, or more typically at least about 500 mg/kg titanium a dry weight basis.

The activated carbon-based sorbent composition can have a relatively high ash level. As will be appreciated, coal ash is a coal combustion residual remaining after coal combustion. Coal ash typically contains a number of minerals, such as aluminum oxide (Al₂O₃), calcium oxide (CaO) silicon dioxide (SiO₂), iron oxide, potassium oxide, magnesium oxide, and other alkali, alkaline earth, transition, and post transition metal oxides. While not wishing to be bound by any theory, one or more of these metal oxides can act as an oxidation catalyst that assists in conversion of contaminants, such as hydrogen sulfide, to a more capturable form, such as S°. The ash content of the carbon-rich material and activated carbon-based sorbent composition typically is at least about 5 wt. % and more typically at least about 6 wt. % (dry or wet basis). The oxidation catalyst content typically is at least about 1 wt. %, more typically at least about 1.5 wt. %, more typically at least about 2 wt. %, more typically at least about 2.5 wt. %, more typically at least about 3 wt. %, more typically at least about 3.5 wt. %, more typically at least about 4 wt. %, and even more typically at least about 4.5 wt. % (dry or wet basis).

In some embodiments, the activated carbon-based sorbent composition may comprise one or more additives, such as catalysts, surfactants, etc. Other sorbent additives may include compounds capable of enhancing the physical or chemical sorption properties of an activated carbon-based sorbent composition for targeting particular contaminants (i.e., contaminant selective agents capable of attracting, sequestering, and/or immobilizing one or more specific contaminants). Other additives to sorbent compositions that are known to those skilled in the art may be included within the sorbent compositions disclosed herein without departing from the scope of the present disclosure.

Non-limiting examples of the one or more contaminant selective agents may be a compound or a group of compounds selected from the group comprising 1,2 hydroxyl groups, 1,2 carboxyl groups, 1,2 carbonyl groups and mixtures thereof; a compound comprising metal oxides and hydroxides (e.g., aluminum oxide, titanium oxide, maghemite, goethite, aluminum hydroxide, iron hydroxide, ferric oxyhydroxide, nickel (II) oxide, cobalt (II) oxide, copper (I) oxide, zirconium dioxide, iron (II, III) dioxide, manganese (II) oxide, lead (II) oxide), activated metal oxides (e.g., activated aluminum oxide), layered double hydroxides (i.e., two metals in hydroxide form) (e.g., hydrotalcite, ettringite, hydrocalumite), metal sulfides (e.g., hydrogen sulfide, zinc sulfide, pyrite, iron (II) sulfide, sodium sulfide), iron (e.g., zero valent iron), and mixtures thereof; a compound comprising phenolic hydroxyl and/or carboxylic groups bonded to aromatic rings and mixtures thereof; and any other compound comprising an anionic functional group and mixtures thereof. Metal oxides, layered double hydroxides, metal sulfides, iron, and mixtures thereof may all have a common metal valency, where in the case of zero valent iron, the iron may convert in solution to comprise a valency. The one or more contaminant selective agents may improve the ability of the base material (e.g., activated carbon) to immobilize and/or remove contaminants in contaminated mediums.

In some embodiments, the one or more contaminant-selective agents that are combined with the base material may be based on the one or more contaminants targeted for removal. In a non-limiting example, the base material may be combined with one or more of 1,2 hydroxyl groups, 1,2 carboxyl groups, 1,2 carbonyl groups and mixtures thereof, which may be selective in sequestering or otherwise removing boron. In a nonlimiting example, the base material may be combined with one or more metal oxides, layered double hydroxides, metal sulfides, iron, and mixtures thereof, which may selectively attract inorganic constituents, such as CCRs via absorption and/or ionic complexing, but may be selective between CCRs. In another non-limiting example, the base carbon material may be combined with organic ligands such as phenolic hydroxyl and/or carboxylic groups bonded to aromatic rings, which may selectively bind some inorganic contaminants over others, such as cobalt. The removal of contaminants may also be facilitated by the use of surfactants as the contaminant-selective agent, either alone or in combination with one or more of the compounds described above. Useful surfactants may include those with charge classification as anionic, cationic, nonionic or amphoteric. By way of example, cationic salts may enable ion displacement of the cation of the surfactant and reaction with the contaminant species, such as boron, to form a new compound that can be immobilized and/or removed from the liquid stream. Examples of such cationic salts include, but are not limited to, quaternary ammonium salts such as quaternary ammonium chlorides, quaternary ammonium bromides and quaternary ammonium methyl sulfates. Additionally, amphoteric salts may be useful to change the ion characteristics based on the pH and ions present in a solution, thus allowing reaction with the contaminant species to form a new compound that can be immobilized and/or removed. Examples of such amphoteric salts include, but are not limited to, those containing nitrogen such as alkyl amidopropyl betaines, alky ampho acetates and alky ampho propionates. Further, cationic and amphoteric surfactants may also function as a flocculent that increase the molecular weight of the contaminant species being immobilized and/or removed. Anionic and nonionic surfactants can also enable the dispersion of borates to facilitate transfer into the porous regions of the sorbent material.

In some applications, an oxidation catalyst naturally occurring in the starting feed material can be supplemented by dosing an oxidation catalyst onto the carbon rich material before or during shaping or before activation. Catalytic oxidation refers to a process that relies on catalysts to introduce oxygen into organic and inorganic compounds. Dosed oxidation catalysts can be uniformly distributed throughout the sorbent material, which is similar to naturally occurring oxidation catalysts.

In embodiments where the activated carbon-based sorbent composition comprises one or more additives, the sorbent composition may comprise an additive content of at least about 0.1 wt. %, such as at least about 1 wt. %, such as at least about 3 wt. %, or at least about 5 wt. %. In one characterization, the sorbent composition comprises at least about 10 wt. % of additives, such as at least about 20 wt. %, such as at least about 25 wt. %, or at least about 30 wt. % (dry or wet basis). In once characterization, the concentration of additives in the sorbent composition is not greater than about 80 wt. %, such as not greater than about 70 wt. %, such as not greater than about 60 wt. %, or even not greater than about 50 wt. % (dry or wet basis). Stated differently, the additives comprises between about 0.5 to about 80 wt. %, or more typically about 10 to 70 wt. %, or more typically about 20 to 60 wt. %, or more typically about 25 to 50 wt. % of the sorbent composition (dry or wet basis).

In some embodiments, the activated carbon-based sorbent composition may include the carbon-comprising feed material and the one or more binders. That is, in some embodiments, the activated carbon-based sorbent does not include any additional additives.

The activated carbon-based sorbent composition of the present disclosure can be in the form of colloidal, powdered, or granular activated carbon. Colloidal activated carbon (or CCP) typically has a D₅₀ size ranging typically from about 0.1 to about 10 μm and more typically from about 0.5 to about 5 μm. Powdered activated carbon (PAC) typically has a D₅₀ size ranging typically from more than about 10 to about 177 μm and more typically from about 15 to about 100 μm. Granular activated carbon (GAC) typically has a D₅₀ size larger than powered activated carbon and typically more than about 177 μm.

Ball pan hardness provides a measure of the degradation resistance or “hardness” of activated carbons. An activated-carbon based sorbent composition of the present disclosure is manufactured to achieve a ball pan hardness of at least about 60% BPH, more typically of at least about 65% BPH, more typically of at least about 70% BPH, more typically of at least about 75% BPH, more typically of at least about 80% BPH, more typically of at least about 85% BPH, more typically of at least about 90% BPH, more typically of at least about 95% BPH, and even more typically of at least about 97.5% BPH.

By contrast, a lignite or other “soft” material-based GAC sorbent might achieve less than about 60% BPH without a binding agent. It is noted that the more an activated carbon-based sorbent is activated, the more the carbon in the sorbent is degraded leading to the increase in pore formation. The hardness of the sorbent, however, will decrease as the activation (and thus pore volume) increases. Therefore, the balance between pore quantity and volume versus BPH may be considered when manufacturing activated carbon-based sorbent compositions of the present disclosure.

It is also noted that BPH can be dependent on particle size. As such, when a conventional GAC (without a binding agent) and GAC reagglomerated with one or more binding agents of the present disclosure are compared like to like (i.e., derived from the same starting material, activated to the same level, the sorbents are of comparable sizes and shapes), surprisingly and unexpectedly, the reagglomerated GAC will achieve a BPH about 10% higher, or more typically about 20%, or more typically about 30% higher, or even more typically about 40% higher than that of the conventional GAC (without a binding agent), particularly when the GACs are derived from a non-conventional GAC or otherwise “soft” carbon-comprising material.

Dust levels or “dustiness” of a shaped sorbent material, such as granular activated carbon or GAC, may refer to the amount of unbound powder on the surface of the sorbent material. An activated carbon-based sorbent material of the present disclosure may comprise a dustiness of less than about 0.6 wt. %, or more particularly less than about 0.5 wt. %, or more particularly less than about 0.4 wt. %, or more particularly less than about 0.3 wt. %, or more particularly less than about 0.2 wt. %, or even more particularly less than about 0.1 wt. % (wet or dry basis). Stated differently, an activated carbon-based sorbent material of the present disclosure may comprise a dustiness between about 0 and 0.5 wt. %, or more particularly between about 0 and 0.4 wt. %, or more particularly between about 0 and 0.3 wt. %, or even more particularly between about 0 and 0.2 wt. % (wet or dry basis). Dustiness of a sorbent material may be measured by screening the sorbent composition via a 325 mesh material, equivalent to about 43 microns. Any material that falls below 43 microns is considered to be dust by weight.

An activated carbon-based sorbent material of the present disclosure can achieve a relatively high abrasion number despite the origin of the base carbon material. Typically, the sorbent composition will achieve an abrasion number greater than about 60%, preferably greater than about 75%, preferably greater than about 80%, and even more preferably greater than about 85%.

An activated carbon-based sorbent material of the present disclosure can have a relatively low iodine number while still being efficacious in removing contaminants. As will be appreciated, iodine number is defined as the milligrams of iodine adsorbed by one gram of carbon when the iodine concentration in the residual filtrate is at a concentration of 0.02 normal (i.e. 0.02N). Basically, iodine number is a measure of the iodine adsorbed in the pores and, as such, is an indication of the pore volume available in the activated carbon of interest. Typically, the hard sorbent composition has an iodine number of no more than about 1000 mg/g, more typically no more than about 900 mg/g, more typically no more than about 800 mg/g, and more typically no more than about 700 mg/g, more typically no more than about 600 mg/g, more typically no more than about 575 mg/g, and more typically no more than about 550 mg/g and typically ranging from about 500 to about 650 mg/g.

An activated carbon-based sorbent material of the present disclosure can include diffusion pores (i.e., transportation pores, mesopores), interior surfaces of which further include sequestration pores (i.e., micropores). The pore sizes of the diffusion and sequestration pores are selected to substantially maximize sequestration of the target contaminant(s). The diffusion pore size, for example, can be typically about 10 or more and more typically about 25 or more times larger than the molecular size of the target contaminant, and the sequestration pore size can be typically no more than about five and more typically no more than about 2.5 times the molecular size of the target contaminant. While not wishing to be bound by any theory, it is believed that the diffusion pores capture and transport the target contaminant particles for adsorption by the sequestration pores through capillary action. Capillary action is the ability of a liquid to flow upward in narrow spaces without the assistance of external forces. In some applications, the pore size distribution is multi-modal (e.g., bimodal).

In one characterization, the activated carbon-based sorbent material has a relatively high total pore volume and a well-controlled distribution of pores, particularly among the mesopores (i.e., from 20 Å to 500 Å width) and the micropores (i.e., not greater than 20 Å width). A well-controlled distribution of micropores and mesopores is desirable for effective removal of contaminants from a contaminated aqueous stream.

In this regard, the sum of micropore volume plus mesopore volume of a sorbent composition of the present disclosure, may be at least about 0.05 cc/g, such as at least 0.1 cc/g, at least about 0.2 cc/g, at least about 0.3 cc/g, at least about 0.4 cc/g, at least about 0.5 cc/g, at least about 0.6 cc/g. The sum of micropore volume plus mesopore volume may range from about 0.05 to about 1 cc/g, or more typically from about 0.1 to about 0.9 cc/g, or more typically from about 0.15 to about 0.8 cc/g, or more typically from about 0.2 to about 0.7 cc/g, or even more typically from about 0.3 to about 0.6 cc/g.

The micropore volume of the composition may be at least about 0.05 cc/g, such as at least about 0.1 cc/g, at least about 0.15 cc/g, at least about 0.2 cc/g, at least about 0.25 cc/g, at least about 0.3 cc/g, at least about 0.35 cc/g, or at least about 0.4 cc/g. In embodiments, the micropore volume of the composition may not be greater than about 0.7 cc/g, or about 0.6 cc/g, or about 0.5 cc/g. The micropore volume of the composition may range from about 0.05 to about 0.7 cc/g, or more typically from about 0.1 to about 0.6 cc/g, or even more typically from about 0.2 to about 0.5 cc/g.

The mesopore volume of the composition may be at least about 0.05 cc/g, such as at least about 0.1 cc/g, at least about 0.15 cc/g, at least about 0.2 cc/g, or at least about 0.25 cc/g. In embodiments, the mesopore volume of the composition may not be greater than about 0.4 cc/g, or about 0.35 cc/g, or about 0.3 cc/g. The mesopore volume of the composition may range from about 0.05 to about 0.4 cc/g, or more typically from about 0.1 to about 0.35 cc/g, or even more typically from about 0.15 to about 0.3 cc/g.

In an embodiment, the ratio of micropore volume to mesopore volume may be at least about 0.2, such as 0.3, 0.4, 0.5, 0.6, or 0.7 and may be not greater than about 2.0, such as 1.9, 1.5, and 1.0. Such levels of micropore volume relative to mesopore volume may advantageously enable efficient capture and sequestration of contaminant species by the sorbent composition. Pore volumes may be measured using gas adsorption techniques (e.g., N₂ adsorption) using instruments such as a TriStar II Surface Area Analyzer 3020 or ASAP 2020 (Micromeritics Instruments Corporation, Norcross, GA, USA).

Thermogravimetric analyzer (TGA) weight loss under inert gas at different temperature ranges measures the amount of oxygen functional groups on a carbon-based surface and may be an indicator of hydrophobicity. The higher the TGA weight loss, the higher the amount of oxygen functional groups and the more hydrophilic (or less hydrophobic) a carbon-based surface is. Lignite typically has a TGA weight loss less than about 4%, and more typically less than about 3%, and even more typically less than about 2%. Bituminous-based carbon typically has a TGA weight loss less than about 3%, more typically less than about 2%, and even more typically less than about 1%. In some embodiments, the activated carbon of the disclosed sorbent composition has a TGA weight loss of less than about 6 wt. %, or less than about 5 wt. %, less than about 4 wt. %, less than about 3 wt. %, or less than about 2 wt. % (in the temperature range of about 400-750° C.). The activated carbon of the disclosed sorbent composition may also have a TGA mass loss of at least 1 wt. % between about 750-900° C., under argon atmosphere.

The present disclosure can provide a sorbent composition tailored to target removal of one or more contaminants by controlling the chemical and/or physical properties of the sorbent composition based at least in part on the chemical and/or physical properties of the target contaminant(s). Such a sorbent composition is not only effective in removing the targets contaminant(s) from contaminated mediums but also can be produced much more inexpensively and at a much higher yield than conventional activated carbon sorbents.

The sorbent material of the present disclosure can be used to remove contaminants from contaminated media by any suitable technique. The media can be a fluid (e.g., gas or liquid) or solid or combination thereof (such as a slurry), optionally under pressure. The contaminant can be any physical, chemical, biological, or radiological substance. Examples include acid gases (such as hydrogen sulfide), mycotoxins, heavy metals, mercury, polychlorinated biphenyls (PCBs), chlorinated solvents including, petroleum hydrocarbons, and per and polyfluoroalkyl substances (PFAS), dioxins, coal ash, radioactive materials, hydrocarbons, odors, pharmaceuticals, radionuclides, and herbicides and pesticides and other organic and inorganic contaminants.

Chlorinated solvents may be used to refer to common groundwater contaminants and their degradation (breakdown products) such as vinyl chloride (VC), tetrachloroethylene (PCE) (also known as perchloroethylene or “PERC”), trichloroethylene (TCE), and dichloroethylene (DCE), which tend to enter the environment through evaporation, leaks, and improper disposal practices. Such contaminants tend to persist in the environment due to a combination of their physical and chemical properties (i.e., distribution coefficients, reactivity, solubility).

Exemplary hydrocarbon contaminants comprise benzene, toluene, ethylbenzene, and/or xylenes (BTEX).

Exemplary PFAS contaminates comprise perfluorooctanoic acid (PFOA), perfluorooctane sulfonic acid (PFOS), and perfluorobutane sulfonic acid (PFBS).

Exemplary coal ash contaminants comprise arsenic, cadmium, chromium, lead, mercury, radium, selenium, and other heavy metals.

Exemplary inorganic contaminants comprise elemental and speciated inorganic materials such as metals, or more specifically alkali metals, alkaline earth metals, transition metals, post transition metals, actinides, lanthanides, and metalloids, and even more specifically arsenic (As), cobalt (Co), lithium (Li), molybdenum (Mo), and boron (B) and compounds thereof. Exemplary contaminants may further include other regulated contaminants in the CCR regulations not explicitly expressed, including antimony, barium, beryllium, bromate, cadmium, chloramines, chlorine, chlorite, chromium, cyanide, fluoride, lead, mercury, nitrate, nitrite, selenium, and thallium and compounds thereof.

Embodiments of the present disclosure are additionally directed to manufacturing an activated carbon-comprising sorbent composition, where a carbon-rich raw material is agglomerated (i.e., blended) with one or more binding agents followed by sizing and chemically or steam activating the composition to form unique sorbent product resulting in a hard, low dust sorbent material having highly engineered adsorptive properties for contaminant sequestration and/or removal.

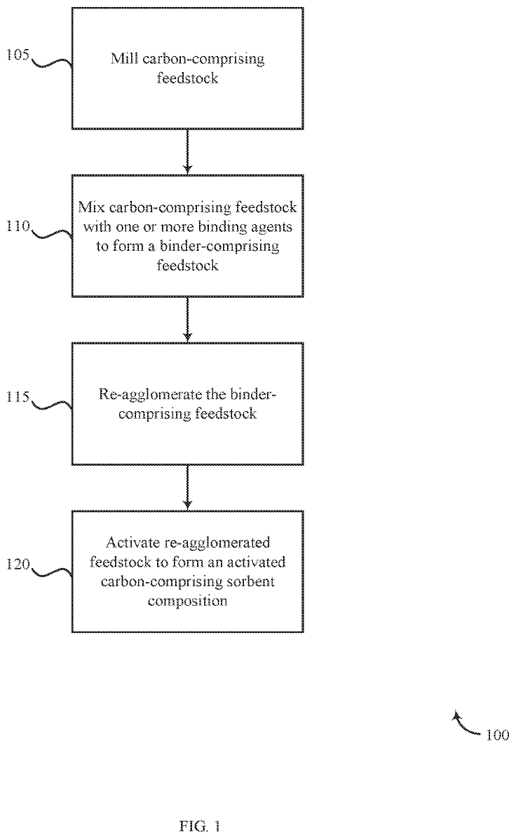

FIG. 1 depicts a flowchart illustrating an example method of manufacturing an activated carbon-based sorbent composition according to embodiments of the disclosure. The steps illustrated in FIG. 1 are provided by way of a non-limiting example. Steps of FIG. 1 may be optional and may occur in an order different than that depicted.

The manufacturing process of the present disclosure begins with a carbonaceous feedstock (e.g., carbon-comprising feedstock) such as a “soft” carbon-comprising feedstock (e.g., lignite coal, PRB coal, wood fiber, peat, soft nutshells) or “dense” carbon-comprising material (e.g., bituminous coal, reagglomerated bituminous coal, coconut) that is not considered coking or metallurgical grade (e.g., non-coking coal), or a combination thereof. Native coal particles of the carbonaceous feedstock may be referred to as agglomerate(s). Although it should be understood that the methods and compositions of the present disclosure may additionally or alternatively use coking or metallurgical grade dense materials as feedstock for manufacturing the sorbent composition.

As depicted in FIG. 1, at step 105, the carbon-comprising feedstock may be milled, ground, or crushed by a mill or other size-reduction device. At step 110, the milled carbon-comprising feedstock may be mixed with one or more binding agents to form a binder-comprising feedstock, as disclosed herein. The binder-comprising feedstock may be mixed with the one or more binding agents until a substantially homogenous mixture is achieved. At step 115, the binder-comprising feedstock is re-agglomerated to form a shaped carbon and binder-comprising composition. At step 120, the reagglomerated feedstock is activated to achieve desired end properties (e.g., pore volume, surface area).

The reagglomerated feedstock may be sized to colloidal, powdered or granular activated carbon. In some embodiments, the agglomerated feedstock may first be sized to GAC, and off-size material may be utilized for powdered activated carbon or PAC and/or CCP. If sized before activation, the sized sorbent material will substantially maintain the same size before, during, and after activation.

A benefit of manufacturing a sorbent by reagglomerating a carbon-comprising material with a binding agent, as disclosed herein, is that the yield of desired sorbent size is increased as compared to a like sorbent manufactured without a binding agent. Particularly with reference to manufacturing a GAC sorbent composition, the amount of off-size material produced from the manufacturing of the binder-comprising GAC is reduced. For example, a low-ranking coal GAC without binder will result in a screening yield of about 30 to 50 wt. % (wet or dry basis). The same low-ranking coal GAC with binder will result in a screening yield greater than about 80 wt. %, or more particularly greater than about 85 wt. %, or more particularly greater than about 90 wt. %, or more particularly greater than about 95 wt. % (wet or dry basis). It should be understood that the lower the screening yield, the higher the amount of off-size material. It should also be understood that screening yield is dependent on the GAC size, and the larger the desired GAC size, the lower the screening yield. In embodiments of the present disclosure, off-size material may be used for the manufacture of PAC, colloidal carbon product (CCP) (or colloidal activated carbon), or both.

In a non-limiting example of the activation process, the reagglomerated feedstock is subjected to an elevated temperature and one or more oxidizing gases under exothermic conditions for a period of time to sufficiently increase surface area, create porosity, alter surface chemistry, and expose and exfoliate native minerals previously contained within feedstock. The specific steps in the process include: (1) dehydration, where the feedstock is heated to remove the free and bound water, typically occurring at temperatures ranging from 100-150° C.; (2) devolatilization, where free and weakly bound volatile organic constituents are removed, typically occurring at temperatures above 150° C.; (3) carbonization, where non-carbon elements continue to be removed and elemental carbon is concentrated and transformed into random amorphous structures, typically occurring at temperatures around the 350-800° C.; and (4) activation, where steam, air or other oxidizing agent is added and pores are developed, typically occurring at temperatures above 800° C. The manufacturing process may be carried out, for example, in a multi-hearth or rotary furnace. The manufacturing process is not discrete and steps can overlap and use various temperatures, gases and residence times within the ranges of each step to promote desired surface chemistry and physical characteristics of the manufactured product. The activated carbon product is then discharged and may be oxygen passivated in a cooling step.

Activated carbon-based sorbent compositions of the present disclosure can be manufactured to have a range of structural properties by the incorporation of one or more activation binders and by varying the conditions of the activation process. These conditions might include a more aggressive activation temperature and steam concentration or the addition of additives during the activation process.

In some embodiments, the one or more additives disclosed herein (e.g., catalysts, contaminant selective agents, surfactants) may be agglomerated with the composition prior to activation or after activation, or a combination thereof. For example, a contaminant selective agent may be reagglomerated with the binder and dried feedstock, or may be added post activation, or both. In another non-limiting example, a catalyst may be reagglomerated with the binder and dried feedstock. In some embodiments, the one or more additives may be combined with the sorbent composition via the incipient wetness technique, wherein an additive-comprising solution is drawn into the pores of a base carbon material via capillary action. Other techniques include spraying the additive-comprising solution onto the base carbon material, impregnating the base carbon material by soaking it in the additive-comprising solution followed by washing steps, reacting the additive to the surface of the base carbon material, or immobilizing the additive on the base carbon material's surface.

As disclosed herein, an activated carbon-comprising sorbent composition is used for the sequestration, immobilization, and/or removal or one or more contaminants from a contaminated medium. The sorbent compositions disclosed herein are particularly useful for the sequestration of contaminants from a contaminated medium, such as soil, groundwater, or flue gases. Thus, the present disclosure also encompasses a method of removing contaminants from a medium by contacting the medium with the activated carbon-based sorbent composition disclosed herein. In an embodiment, a method for the application (e.g., use) of the sorbent composition of matter is disclosed.

The contaminated medium to be treated can be predominantly liquid-phase by volume. Stated differently, the contaminated medium typically comprises more than about 50% by volume liquid and even more typically more than about 75% by volume liquid. The effluent can comprise entrained solid or gas particles, such as a slurry. Exemplary liquid-phase contaminated mediums comprises groundwater.

The contaminated medium to be treated can be predominantly solid-phase by volume. Stated differently, the contaminated medium typically comprises more than about 50% by volume solid and even more typically more than about 75% by volume solid. Exemplary solid-phase contaminated mediums comprises soil.

The contaminated medium to be treated can be predominantly gas-phase by volume. Stated differently, the contaminated medium typically comprises more than about 50% by volume gas and even more typically more than about 75% by volume gas. The effluent can comprise entrained liquid or solid particles. Exemplary gas-phase contaminated mediums comprises flue gases.

As is known to those of skill in the art, the sorbent composition including the activated carbon and one or more binders may be contacted with a medium (to remove contaminants in a wide variety of ways. For example, the sorbent composition may be applied to a municipal water treatment process through a pressure vessel or through a gravity filter. The sorbent composition may also be applied to a contaminated site via in situ trenching, or applied via ex situ or above-ground treatment systems, or the like. The sorbent composition may be placed in a cartridge, column, or similar structure through which a medium flows or rests. In another example, the sorbent composition may be placed on or within a membrane (e.g., a planar membrane) through which the medium flows or rests. The sorbent composition can be adhered or otherwise attached to a substrate, such as filtration cloth or other reactive or non-reactive (e.g., chemically inert) substrate. The sorbent composition may also be shaped into an integral structure (e.g., a honeycomb structure, porous carbon blocks) or may be incorporated into such a structure (e.g., a ceramic honeycomb structure). The sorbent composition may also be used in a permeable reactive barrier, such as where the sorbent composition is either buried in a trench or is injected into the subsurface to treat contaminated groundwater. The sorbent composition may also be applied to contaminated soil through mechanical mixing (e.g., tilling or plowing).

The methods and systems of the present disclosure are further described by way of the following illustrative, non-limiting experimental Examples 1 and 2.

### Example 1

When using the same lignite coal feedstock, as in Table 1, the process of using a binder and reagglomerating the particles versus not doing so leads to dramatically enhanced Ball Pan Hardness (BPH) and screening yield while improving H₂S adsorption performance.

The two directly activated lignite GAC of Table 1 differ in activation levels caused by varying activation conditions, such as higher temperature and higher steam/feed ratio that resulted in an increased amount of large mesopores but reduced the hardness of the carbon (i.e., 41% versus 48% BPH).

TABLE 1
Adsorption and physical properties of GAC for H₂S removal.

| | | | H₂S | | 4 × 10 |
|---|---|---|---|---|---|
| | H₂S | Apparent | loading | | Screening |
| | capacity | Density | Capacity | | Yield |
| Description | (g/cc) | (g/cc) | (wt. %) | BPH | (%) |
| Directly activated | 0.17 | 0.37 | 47% | 41% | 25% |
| lignite GAC 4 × 10 | | | | | |
| Directly activated | 0.16 | 0.39 | 43% | 48% | 25% |
| lignite GAC 4 × 10 | | | | | |
| Reagglomerated | 0.27 | 0.38 | 73% | 65% | 85% |
| lignite GAC 4 × 10 | | | | | |

### Example 2

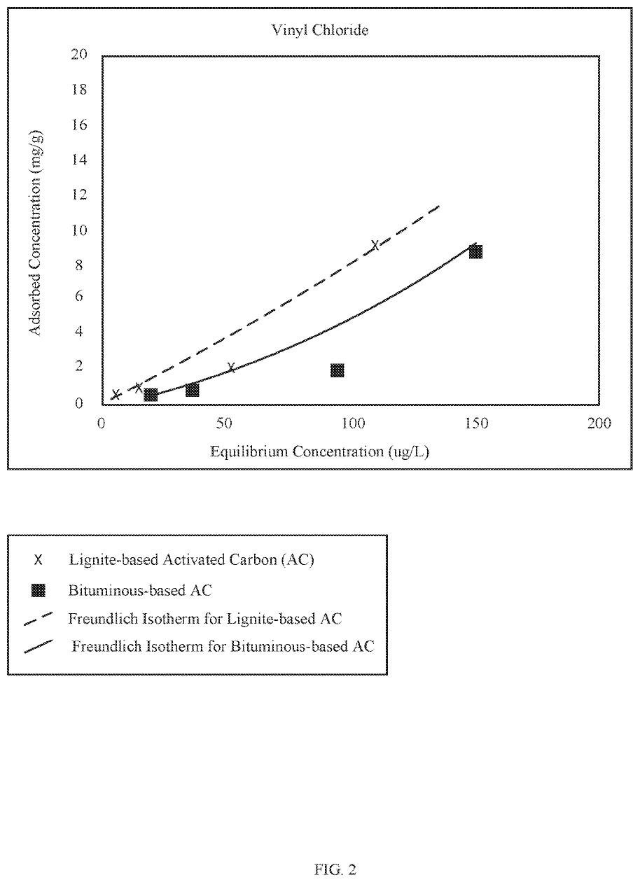

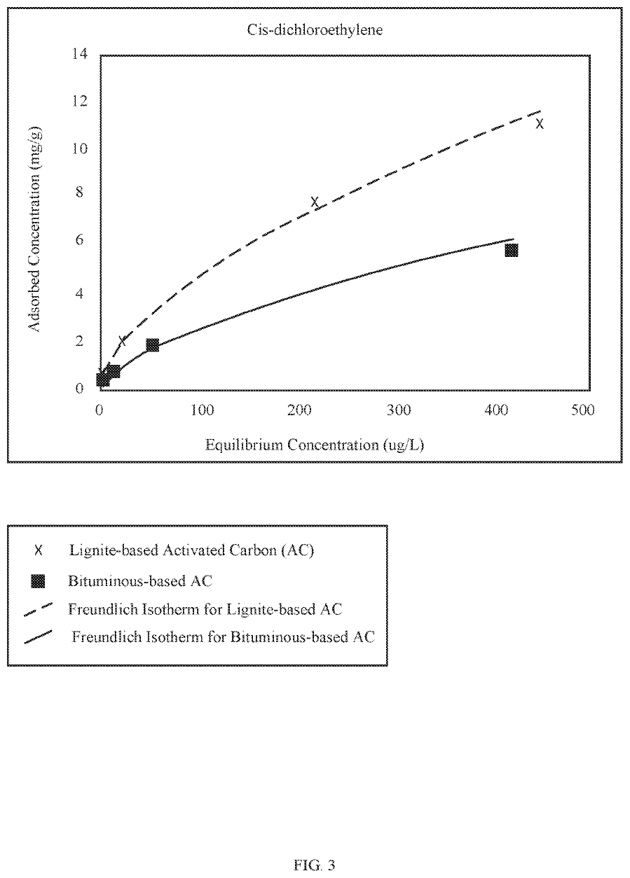

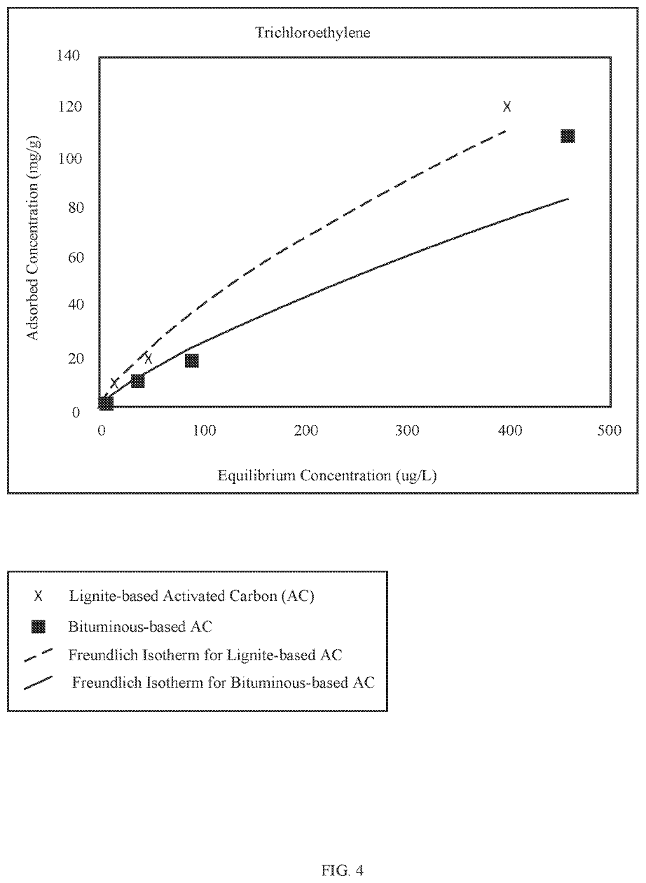

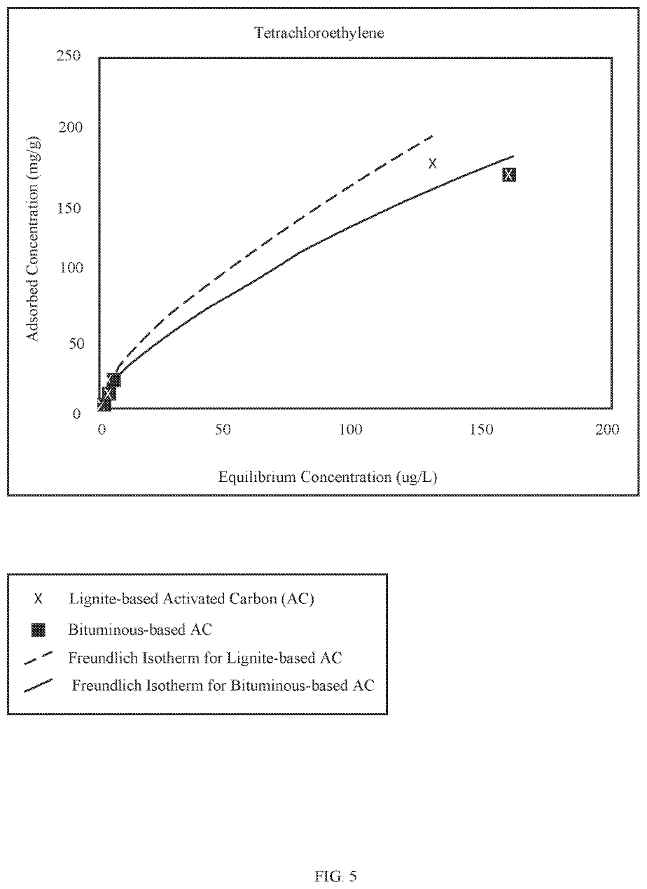

FIGS. 2 to 5 illustrate Freundlich Isotherm plots showing the adsorption performance of lignite-based AC versus bituminous-based AC for vinyl chloride, cis-dichloroethylene, trichloroethylene and tetrachloroethylene adsorption (i.e., chlorinated solvents from synthetic groundwater), respectively, according to an embodiment of the disclosure.

As depicted in FIGS. 2 to 5 for chlorinated solvent removal, the chemisorptive properties of lignite-based activated carbon led to enhanced adsorption capacity, but application with GAC is limited due to the softness of direct activated lignite. In order to utilize this carbon in the granular form, the inherent hardness of the lignite-based GAC needs to be enhanced with the process described in this application.

Surprisingly and unexpectedly, it has been discovered that a low ranking coal and/or a coal with a low iodine number, such as lignite, can be reagglomerated to form a hard sorbent material with preferred contaminant adsorption capacity as compared to using a higher ranking coal, such as bituminous coal. In one non-limiting example, the hard sorbent material disclosed herein may have a higher chemical adsorption capacity, as compared to conventional sorbents formed from high ranking coal (i.e., bituminous coal).

Although descriptions herein describe the use of coal, and in particular lignite coal, other carbon-rich substrates which when activated form a weak activated carbon-based sorbent can rather be treated according to methods of the present disclosure to form a sorbent composition exhibiting high mechanical strength properties sufficient for industry application.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

A number of variations and modifications of the disclosure can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A carbon-comprising sorbent material, comprising:
a carbon-rich material; and
one or more binding agents,
wherein the carbon-comprising sorbent material comprises a medium particle size greater than about 177 μm and comprises a ball pan hardness of at least about 60%.

2. The carbon-comprising sorbent material of claim 1, comprising a ball pan hardness of at least about 65%.

3. The carbon-comprising sorbent material of claim 1, comprising a dust level less than about 0.4 wt. % (dry basis).

4. The carbon-comprising sorbent material of claim 1, comprising a total pore volume of at least about 0.2 cc/g.

5. The carbon-comprising sorbent material of claim 1, comprising a ratio of micropore volume to mesopore volume of at least about 0.2 and not greater than about 2.0.

6. The carbon-comprising sorbent material of claim 1, wherein the carbon-rich material is derived from lignite coal, sub-bituminous coal, Powder River Basin (PRB) coal, wood, peat, nutshells, non-coking coal, and a combination thereof.

7. The carbon-comprising sorbent material of claim 1, wherein the one or more binding agents comprise a green strength binder selected from the group comprising hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, xanthan gum derivatives, guar gum derivatives, hydroxypropyl guar gum, Polyacrylates derivatives, Acrylates/C10-C30 Alkyl Acrylate cross-polymer, Carbomer, and Polyacrylate-1 cross-polymer.

8. The carbon-comprising sorbent material of claim 1, wherein the one or more binding agents comprise an activation binder selected from the group comprising gilsonite, resinous rock, asphalt, asphalt, uintahite, coal tar pitch, petroleum pitch, oil sands, bitumen, resinous hydrocarbon, heavy oil, carbon pitch, coal tar distillates, clays, and mixtures thereof.

9. The carbon-comprising sorbent material of claim 1, wherein the carbon-rich material and the one or more binding agents are homogenously distributed in the carbon-comprising sorbent material.

10. A method of manufacturing an granular activated carbon-rich sorbent material, comprising:
combining a carbon-rich feedstock material with one or more binding agents to form an intermediate composition;
forming the intermediate composition into granules comprising a medium particle size greater than about 177 μm to form a granular intermediate composition; and
activating the granular intermediate composition to form the granular activated carbon-rich sorbent material.

11. The method of claim 10, wherein the granular activated carbon-rich sorbent material comprises a ball pan hardness of at least about 60%.

12. The method of claim 10, wherein the granular activated carbon-rich sorbent material comprises a dust level less than about 0.4 wt. % (dry basis).

13. The method of claim 10, wherein the granular activated carbon-rich sorbent material comprises a total pore volume of at least about 0.2 cc/g.

14. The method of claim 10, wherein the granular activated carbon-rich sorbent material comprises a ratio of micropore volume to mesopore volume of at least about 0.2 and not greater than about 2.0.

15. The method of claim 10, wherein the carbon-rich feedstock material is derived from lignite coal, sub-bituminous coal, Powder River Basin (PRB) coal, wood, peat, nutshells, non-coking coal, and a combination thereof.

16. The method of claim 10, wherein the one or more binding agents comprise a green strength binder selected from the group comprising hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, xanthan gum derivatives, guar gum derivatives, hydroxypropyl guar gum, Polyacrylates derivatives, Acrylates/C10-C30 Alkyl Acrylate cross-polymer, Carbomer, and Polyacrylate-1 cross-polymer.

17. The method of claim 10, wherein the one or more binding agents comprise an activation binder selected from the group comprising gilsonite, resinous rock, asphalt, asphalt, uintahite, coal tar pitch, petroleum pitch, oil sands, bitumen, resinous hydrocarbon, heavy oil, carbon pitch, coal tar distillates, clays, and mixtures thereof.

18. The method of claim 10, wherein the combining step comprises homogenously distributing the carbon-rich feedstock material and the one or more binding agents to form the intermediate composition.

19. An activated carbon-comprising sorbent composition, comprising:
a carbon-rich material derived from a feedstock comprising one or more of lignite coal, sub-bituminous coal, Powder River Basin (PRB) coal, wood, peat, and nutshells; and
one or more binding agents,
wherein the carbon-comprising sorbent material comprises a ball pan hardness of at least about 60%.

20. The activated carbon-comprising sorbent composition of claim 19, wherein the activated carbon-comprising sorbent composition comprises a medium particle size greater than about 177 μm.

21. The activated carbon-comprising sorbent composition of claim 19, wherein the activated carbon-comprising sorbent composition comprises ball pan hardness of at least about 75%.
